(19) United States
(12) Patent Application Publication
(10) Pub. No.: US 2003/0028894 A1
(43) Pub. Date: Feb. 6, 2003

(54) Access node for multi-protocol video and data services

(75) Inventors: Gerald R. Joyce, Newton, MA (US); Timothy M. Burke, Norton, MA (US); Walter Greene, Mansfield, MA (US); David Grubb, Doylestown, PA (US); George Arthur Harvey, Bedford, MA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument, Inc.

(21) Appl. No.: 10/198,345

(22) Filed: Jul. 18, 2002

Related U.S. Application Data
(60) Provisional application No. 60/306,328, filed on Jul. 18, 2001.

(51) Int. Cl. H04N 7/173; H04L 12/28; H04L 12/56

(52) U.S. Cl. 725/118; 725/119; 725/127; 370/408

(57) ABSTRACT

An access node that is deployable at a distance from a cable company head-end or a telephone company central office serves residential and business subscribers within a small geographical area. The access node provides interoperability between and across communications links and protocols, thereby providing a modular, configurable access point for both business and residential users that enables the service provider to tailor its services for each user in a cost-effective manner. The access node includes modular interfaces to multiple communications links and protocols on its network side and modular interfaces to multiple communications links and protocols on its user or access side. A switch/router connects the outputs of the two interfaces together and aggregates traffic to the network while simultaneously partitioning traffic to the users to the appropriate connections.

### STATEMENT OF RELATED APPLICATION

This application claims the benefit of priority to U.S. Provisional Patent Application 60/306,328, filed Jul. 18, 2001 and entitled “Access Node for Multi-Protocol Video and Data Services.”

### FIELD OF THE INVENTION

The present invention relates generally to methods and apparatuses for communicating between users and a communications network, and more particularly to a method and apparatus for communicating between a user and a communications network involving multiple protocols and different physical links.

### BACKGROUND

Various access data and video systems have strengths and weaknesses for residential or business services. For instance, first, the Data-Over-Cable-System-Interface-Specification (DOCSIS) is not optimized for business services making it difficult for cable companies to offer data services to businesses. For example, if a business wanted symmetric data services at an OC-1 rate of 55 Mbps, this would be next to impossible to provide on a DOCSIS system. The upstream capacity for DOCSIS is limited to a net of approximately 15 Mbps for a 16-QAM carrier at 5 Msymbols/sec, which is the current maximum. To provide an upstream capacity of 55 Mbps, one would have to provision four of these DOCSIS upstream channels, and then work out some multiplexing scheme to allocate the traffic over these channels. In addition, the business could not share the upstream spectrum with any other users, meaning that the business would have to have its own optical node. This might well require installation of a new optical fiber from the cable head-end to the vicinity of the business, which may be as far away as 25 km.

Second, it is difficult and expensive to extend data services via fiber to businesses located in residential areas. Generally, such data services are provided via SONET. The businesses must have access to SONET add/drop multiplexers and this can require the installation of fiber links to bring the businesses into SONET rings. In densely populated urban areas this is not so much of a problem, but in residential areas where many business parks are located, bringing businesses into SONET rings can be prohibitively expensive.

Third, it is difficult to provide digital services over fiber to homes and businesses from a distant head-end or central office via individual point-to-point links from the head-end to each home or business. These individual fiber links may extend over a distance of 25 km or more and may only amount to 10 Mbps or less of average traffic per link. Allocating a specific fiber or wavelength for each subscriber is prohibitively expensive.

Fourth, cable companies cannot use conventional hybrid-fiber-coax systems to deploy fiber-to-home/businesses without expensive upgrades. The desire is to extend fiber to the home and business in the form of base-band optical links carrying full duplex Ethernet. Even if there is an optical node placed by the cable company in the vicinity of the home/business, the optical link for that home/business must be upgraded to a point-to-point optical link extending all the way from the cable company head-end to the home/business, which can be a distance of 25 km or more, which is too expensive to justify on a cost/benefit analysis.

Fifth, there is no way to aggregate the traffic from variety of access technologies at a location very distant from the head-end or central office. Rather, there are individual access technologies, such as HFC, passive-optical networks, SONET rings, Fiber-distributed-Data-Interface (FDDI) rings. Each of these operates separately from the other.

Consequently, the prior art is a set of access architectures, such as: DOCSIS, which operates over the HFC system, passive-optical networks carrying ATM or Ethernet, SONET rings, FDDI rings and other optical rings. The primary shortcomings of these systems are as follows. First, none of these systems can provide complete video services at an economical price and also provide fiber-to-home/businesses. Second, each of these architectures is independent of the others, and is incapable of interoperating with the others in any simple manner. Third, each of these architectures is incapable of aggregating traffic from any of the others in any direct manner.

The present invention is therefore directed to the problem of developing a method and apparatus for communicating between a user and a communications network that operates with a variety of communication protocols while avoiding the above shortcomings.

### SUMMARY OF THE INVENTION

The present invention solves these and other problems by providing an access node that is deployable at a distance from a cable company head-end or a telephone company central office, which access node serves residential and business subscribers within a small geographical area.

According to one aspect of the present invention, the access node provides interoperability between and across communications links and protocols, thereby providing a modular, configurable access point for both business and residential users that enables the service provider to tailor its services for each user in a cost-effective manner.

### BRIEF DESCRIPTION OF THE DRAWINGS

FIG. 1 depicts an exemplary embodiment of a communications network according to one aspect of the present invention.

FIG. 2 depicts an exemplary embodiment of an access node according to another aspect of the present invention.

FIG. 3 depicts another exemplary embodiment of an access node according to yet another aspect of the present invention.

FIG. 4 depicts an exemplary embodiment of downstream connections for a coaxial cable connection output from an access node according to yet another aspect of the present invention.

FIG. 5 depicts an exemplary embodiment of a combined HFC and access node network according to yet another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

One exemplary embodiment of the present invention includes an access node for use in a telecommunications network, such as a cable network or other high-speed data communications network. An access node comprises a data-networking node that is deployed at a distance from a cable company head-end or a telephone company central office (e.g., at a distance of perhaps 25 km) and serves residential and business subscribers within a small geographical area.

The access node has two sides—a network side and an access side. The network side supports a fiber optic connection at the cable company head-end (or telephone company central office) and the access side supports connections to residential and business subscribers. For example, the access side includes interfaces to both coaxial and fiber optic cables. The network side includes interfaces to high-speed fiber optic cables and lower bandwidth fiber optic cables.

Both the network side and the access side have a set of various modules with which to support differing communication protocols. This enables the access node to accommodate a wide variety of communications protocols in a single node, which was heretofore not possible. Thus, for example, the network side will have modules for: (1) full-duplex Ethernet over fiber connections; or (2) passive-opticalnetworks; or (3) SONET rings. Similarly, for example, the access side will have modules for: (1) the DOCSIS protocol, which will operate over coaxial cables to the home (these coaxial cables may also carry broadcast video as RF signals); (2) full duplex 10/100 Mbps Ethernet over fiber; (3) passive optical networks carrying either ATM or Ethernet frames to the home or business. The Access Node has the ability to support more than one access protocol at the same time by selecting more than one type of access module—one access protocol for each connection.

According to one possible implementation of the access node, it may be that some of the functions for the access technologies are performed not in the modules dedicated to those access technologies, but in the central processor of the Access Node. The reason is that the Access Node will be based on a network processor to whose ports the various access modules are attached. Network processors combine the speed of hardware implementation of common routing and switching functions, such as header parsing and manipulations, table look-ups, queue operations and packet forwarding, with the flexibility of software implementation of complex and protocol-specific functions. This allows support for a variety of switching and control protocols that may change according to need, while still providing wire-speed switching of data. Such network processors have sufficient processing power to perform some computations for the access technology deployed to the subscriber. For instance, in the case of DOCSIS to the subscriber some calculations necessary to the operation of the DOCSIS standard (such as computation of the MAP's specifying upstream transmissions by the cable modems) may be done not in the DOCSIS module itself, but by the network processor to which this DOCSIS module attaches. This is simply an economical means of keeping the DOCSIS module as simple as possible by using some of the computational power of the network processor (and any associated processors) for DOCSIS computations.

The Access Node operates as a packet switch partitioning downstream traffic to the various subscriber interfaces and aggregating upstream traffic to a single optical link, which is ultimately delivered back to the head-end. By aggregating the incoming traffic from the downstream subscribers and partitioning the incoming traffic from the network, the access node enables the use of high-speed fiber to some homes and businesses while simultaneously accommodating those homes with only coaxial cable installed (via DOCSIS).

One of the achievements of the present invention is that the Access Node has the ability to support economical broadcast video services to residential subscribers. This is accomplished by overlaying the Access Node onto an HFC video distribution system (see FIG. 3). The broadcast video is still transmitted via RF carriers on an analog optical link from the cable Headend to an optical node, at which point these RF carriers are inserted into the coaxial plant in the same way as before (HFC architecture). In the Access Node architecture the conventional optical node of the HFC gains a dual role in that it retains its old functions and becomes, in addition, an Access Node. One could also say that the conventional HFC optical node is co-located with the Access Node. The Access Node uses the same RF filters and electronic amplifiers (which are part of the HFC optical node) to drive signals into the same coaxial plant.

In addition to the broadcast video, there is narrow cast traffic that is delivered via the coax plant by the Access Node. The narrow cast traffic, which is unique to those subscribers served by a particular Access Node, includes Internet traffic (DOCSIS data), video-on-demand (VOD) and voice-over-IP (VoIP). This traffic is carried as packets on the base-band optical link from the head-end to the Access Node. Since that traffic is destined to reach the subscriber over the coaxial cable plant, it is converted to RF carriers for transport in the Access Node. By doing the base-band to RF conversion in the Access Node, it is possible to attain a high degree of frequency re-use for narrow-cast traffic from one Access Node to another Access Node.

A second achievement of the present invention is that the Access Node can support fiber connections to homes and businesses by installing an appropriate access module to support a particular optical technology. For instance, one type of module may support Ethernet over Passive Optical Networks, while another module may support a star network of 10/100 Mbps full-duplex Ethernet links. Thus, one can extend data services to businesses without using DOCSIS for businesses and without constructing a SONET ring to serve those businesses.

A third aspect of the present invention is that those fiber links installed for businesses and homes do not have to extend all the way to the cable company head-end (e.g., up to 25 km). Instead, the fiber connection need only extend over the distance from the business to the Access Node, which is limited to a few kilometers. This means that the 10/100 Mbps Ethernet links can use inexpensive optical technology based on multi-mode fiber for the shorter distances (i.e., 500 meters or less).

Fourth, if the cable company should desire to shift residential services from coaxial-to-the-home to fiber-to-the-home, this can be done on an incremental basis, without replacing the fiber network connecting the Access Node to the headend, and without disturbing the coaxial cable plant. All that needs to be done is to install fiber from the Access Node to the various residences to be upgraded (to fiber).

Fifth, by using various access-side modules, the Access Node can simultaneously support multiple access networks to residences and businesses. The traffic from these various access protocols are aggregated in the Access Node and carried over unified optical links to and from the head-end (or central office).

It may be desirable to carry all video services on a fiber-to-the-home basis, including broadcast video. The Access Node architecture can be migrated to support this architecture. There are several ways to do this.

The most conceptually trivial way is to transport the broadcast video RF carriers over fiber-to-the-home. The RF carriers need not be changed, but simply carried over fiber.

Another general approach to offering full video services over fiber to the home is to deliver both broadcast and narrow-cast video as MPEG packets over a baseband optical link. In this case there are no RF carriers at all. On another note, MPEG programs for entertainment video on standard resolution TV screens require 3 Mbps-6 Mbps. If there are 100 ‘broadcast video’ streams, this means a potential 600 Mpbs worth of MPEG packets. If we wish to use 100 Mbps Ethernet to the home, then that link will not accommodate all the broadcast video. There must be some way for the subscriber to signal to the Access Node, which programs he/she wishes to view, and for only this material to be transmitted to the home.

Another way to accomplish this video service architecture is by providing that all “broadcast” video be carried from the head-end to the Access Node as MPEG packet streams on the base-band optical link. A control protocol between the subscribers and the Access Node allows the subscribers to select which MPEG packet streams (e.g., which video content) they want to view in their homes. The selected MPEG packet streams are then switched to and sent over the lower bandwidth base-band optical links from the Access Node to the subscribers' homes.

Yet another way to achieve the video architecture is if the subscribers use a control protocol, which extends from their homes to both the Access Node and the head-end. In this case, the subscribers at home select the MPEG packet streams; and these selections are communicated to both the head-end and the Access Node. Those broadcast streams that are selected by the subscribers of a particular Access Node (and no others) are sent from the head-end to that Access Node. At the Access Node, the MPEG video packet streams are switched in the same manner as in the above case and carried via fiber links to the homes of the subscribers that have selected them.

What is beneficial about this second approach is that only those broadcast video MPEG packet streams which are actually being selected by subscribers (served by a particular Access Node) are carried from the head-end to that Access Node at any one time. For instance, the cable company may wish to identify as many as 300 separate MPEG video streams which are considered as “broadcast” and are available at the head-end at all times. These 300 video streams may comprise an aggregate of 300×5 Mbps-1500 Mbps of digital content. The subscribers of a particular Access Node may have only selected 30 of these streams at a particular time. That is, only 30 out of 300 “broadcast” video streams are being viewed (or recorded), for a total digital load of 30×5 Mbps=150 Mbps. Thus, the transport and switching (including packet dropping) loads from the head-end to the Access Node are reduced from 1500 Mbps to 150 Mbps. This can lead to much less expensive optical links from the head-end to the Access Node, as well as lower capacity switching (including packet dropping) in the Access Node itself.

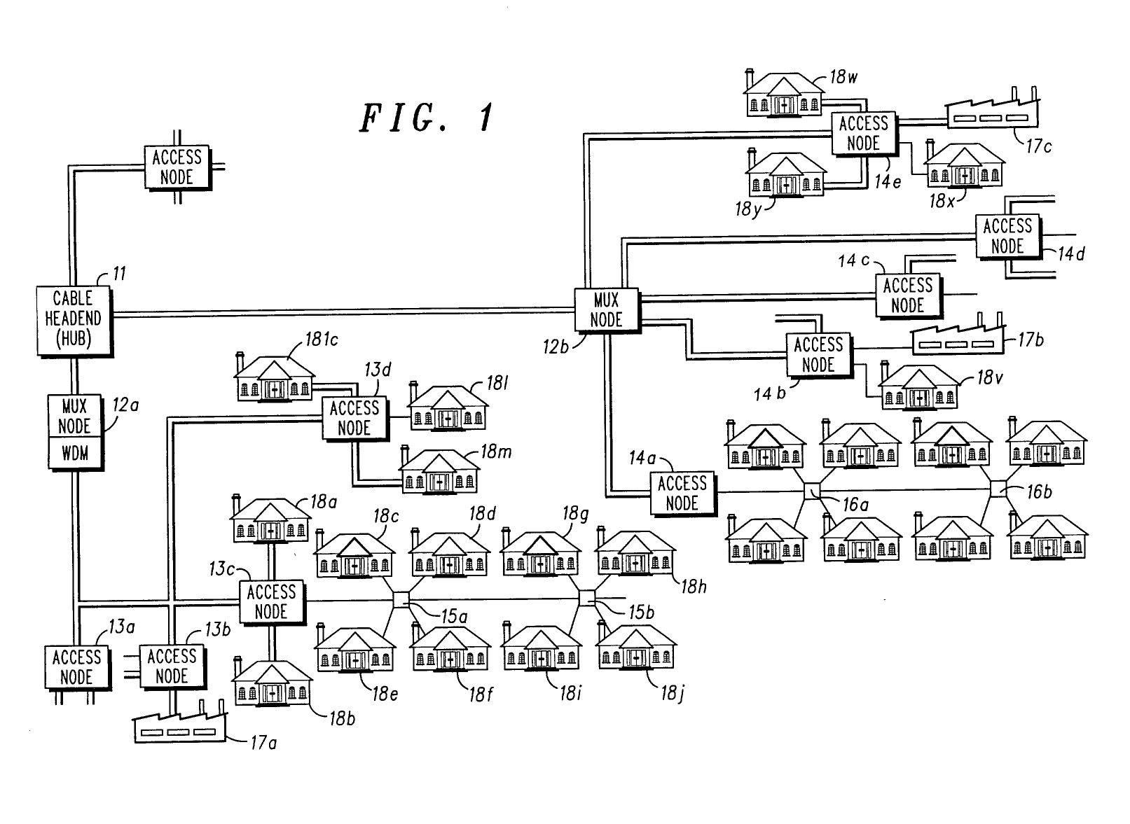

Turning to FIG. 1, shown therein is a communications network architecture that incorporates access nodes as described above. A cable head-end 11 is coupled to two mux nodes 12a and 12b. A cable head-end may be coupled to many mux nodes, probably limited by the number of subscribers serviced by a headend divided by the number serviced by a mux node. Each of the mux nodes 12a, 12b is coupled to multiple access nodes 13a-d, 14a-e. It is also possible that a single access node is connected directly to a cable headend (or telephone company central office) without any mux node in between. Moreover, there may be approximately 10 central office) access nodes for each mux node. The limit is the ratio of an economical packet switching capacity in a mux node to that in an Access Node.

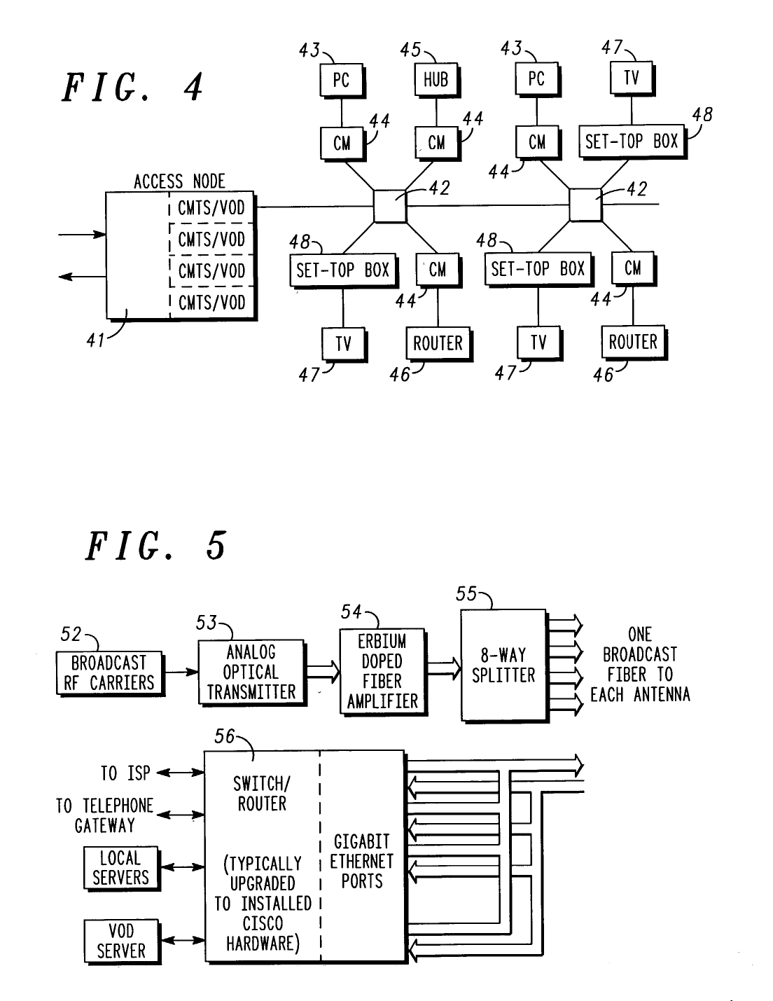

Each access node 13a-d, 14a-e is coupled to one or more users, which include homes, businesses and other potential users. In some cases, several users may be served by a tap (e.g., 15a-b, 16a-b), to which each of the users is coupled and which tap (e.g., 15a-b, 16a-b) in turn is coupled to the access node (e.g., 13c and 14a, respectively). Moreover, a single tap 15a-b, 16a-b may be coupled to other taps. FIG. 4 depicts additional details regarding the coaxial cable connection.

Mux Node 12a is a wavelength division multiplexing node that transmits unique wavelengths (λ₁, λ₂, λ₃, λ₄) to each access node (13a-d, respectively). In this embodiment, mux node 12a is coupled to the access nodes 13a-d via a 1 Gbps or 100 Mbps Ethernet fiber connection. In turn, the mux node 12a is coupled to the cable head-end (or hub) 11 also via a fiber connection. Each access node 13a-d, 14a-e may serve approximately 20-125 homes.

Access node 13a is coupled to its users (not shown) via fiber so that a complete fiber connection exists from each user coupled to access node 13a to cable head-end 11.

The same is true for access node 13b, which in turn has business user 17a connected to it via fiber. Other users of access node 13b are not shown.

With regard to access node 13c, there is a complete fiber connection to the access node 13a. Some home users 18a-b are connected to the access node 13c via fiber, whereas other home users 18c-j are coupled to the access node 13c via coaxial cable via taps 15a-b. In this case, home users 18c-f are coupled via coaxial cable to tap 15a and home users 18g-j are coupled via coaxial cable to tap 15b. In turn taps 15a and 15b are coupled to each other via coaxial cable and then to the access node 13c via coaxial cable.

With regard to access node 13d, which is served by λ₄, home users 18k, 18m are served by fiber, whereas home user 181 is served by coaxial cable.

Turning to mux node 12b, this mux node is coupled to the cable headend 11 via a fiber connection that may be up to 15 km in length, which operates an Ethernet connection at 1 or 10 Gbps. Each of the access nodes may be up to 2 km in distance from the mux node. In this case, mux node 12b is coupled to each of the access nodes 14a-e via a fiber connection.

Access node 14a is coupled via coaxial cable to two taps 16a-b, to which multiple home users 18n-u are coupled over a coaxial cable. Each user or subscriber has a 1 Mbps to 100 Mbps capacity connection.

Access node 14b is coupled to a business user 17b via a coaxial connection and a home user 18v also via a coaxial connection. Additional users (not shown) may be connected to access node 14b via fiber, for example.

Access node 14c may serve both fiber and coaxial connected users (not shown). The same is true for access node 14d.

Access node 14e is coupled to three home users 18w-y and one business user 17c. Home user 18x is coupled to access node 14e via coaxial cable, whereas home users 18w, 18y and business user 17c are coupled to access node 14e via fiber.

The above-described connections are merely exemplary to show the vast variety of connections made possible by the access node of the present invention. Many other possible combinations can be made without departing from the present invention. The access node of the present invention makes possible complex combinations of business and residential users over mixed cable and fiber connections operating at different communications data rates and protocols.

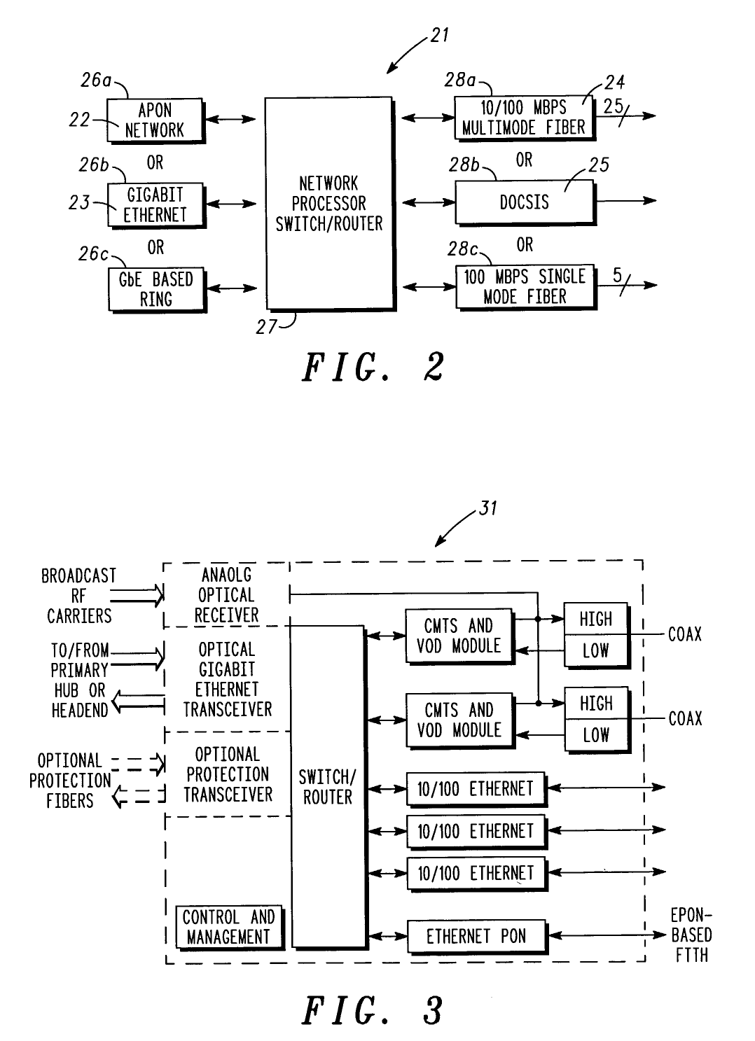

Turning to FIG. 2, shown therein is a exemplary embodiment of a hardware implementation of an access node according to another aspect of the present invention. Access node 21 is enclosed in an environmentally hardened enclosure for external use. The dimensions of access node 21 are approximately six inches by four inches by four inches, which should be sufficient to house multiple network cards and cable and fiber connection interface cards.

In this embodiment 21, the access node includes a communications card 22, an input line card 23, and 10/100 Mbps card 24 and a DOCSIS card 25. Logically, the access node 21 includes multiple network cards 26a-c (e.g., APON network, Gigabit Ethernet or GbE Based Ring cards) coupled to a switch 27, which in turn is coupled to multiple interface cards 28a-c (e.g., 10/100 Mbps multimode fiber, DOCSIS, or 100 Mbps single mode fiber interface cards). There can be a variety of cards, e.g, 10/100 BaseT, 10/100 BaseF, 10 Base2, 1000 BaseF, or DOCSIS to name only a few. Thus, any network on the network side can be coupled to any interface on the access side via switch 27, which operates like a cross-connect switch.

Turning to FIG. 3, shown therein is an exemplary embodiment 31 of an access node according to yet another aspect of the present invention. On the network side of the access node there are two optical inputs/outputs. One fiber optical input consists of the broadcast RF carriers. This fiber is properly the input to the optical node of the HFC network to which the Access Node network is overlaid. As noted above, the Access Node is co-located with the optical node of the HFC network. They both attach to the same coax trunks. The broadcast RF carriers are input to an analog optical receiver. The output of the optical receiver is provided to a high band transmitter for transmission over the coaxial cable on the access side. A second input/output is a fiber input including baseband optical links for narrow-casting, e.g., a Gigabit Ethernet.

The access side includes a coaxial cable output and a multimode fiber to the home/ business input/output, each of which are coupled to a 10/100 Ethernet card, which in turn is coupled to a packet switch. The packet switch is coupled to the optical receiver/transmitter (or transceiver) that receives the baseband optical links for narrow-cast. The downstream traffic for the CMTS and VOD arrives on the baseband optical link from the headend and is converted into appropriate RF carriers for the coax cable, is mixed with the output from the analog optical receiver and transmitted in the high band on the coaxial cable. The CMTS and VOD module also receives input from the coaxial cable on the low band.

Turning to FIG. 4, shown therein is the downstream connections for a coaxial cable connection output from an access node, such as shown in FIG. 1. The access node 41 outputs multiple CMTS/VoD channels (e.g., four downstream and three upstream shown) to various users coupled to the passive tap 42. The users may have varying equipment configurations, including personal computers 43, cable modems 44, hubs 45, routers 46, televisions 47, and set-top boxes 48. On the downstream side, there are 4 RF DOCSIS /VOD carriers 6 MHz wide, 256-QAM each, serving up to 125 homes. As such, this provides 140 Mbps for 125 homes, or about 1.1 Mbps per home passed. On the upstream side, there are 4 DOCSIS carriers, 6 MHz wide, 16-QAM each serving up to 125 homes. This provides 60 Mbps data for the 125 homes, or about 480 kbps data per home passed.

Turning to FIG. 5, shown therein is a combined HFC and access node network 51 according to yet another aspect of the present invention. The top portion of FIG. 5 includes the HFC portion of the network and the bottom portion of FIG. 5 includes the access node portion of the network.

The broadcast RF carriers 52 are coupled to an analog optical transmitter 53 and over a fiber optic connection to an erbium doped fiber amplifier 54. The output of the amplifier 54 is broadcast RF on one fiber, which is split via splitter 55 so that one fiber is sent to each access node (not shown). One possible implementation splits the RF broadcast into 8 identical fibers.

On the access side of the network, the data to and from the Internet Service Provider (ISP) is transmitted to a switch/router 56. All telephony traffic is similarly coupled to the switch/router 56. Local server data and VoD data is also coupled to the same switch/router 56. This data is then multiplexed into multiple high-speed fiber optic connections, each having a unique wavelength. These highspeed fiber connections are coupled to the various access nodes.

In some cases, the data is transmitted using a coarse wavelength division multiplexing (CWDM) scheme. In other cases, the data may be transmitted using point-to-point fiber to each access node.

Although various embodiments are specifically illustrated and described herein, it will be appreciated that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

What is claimed is:

1. An apparatus for use in a communications network for deployment up to 25 km from a cable head-end or telephone company central office and between a plurality of business and residential users within a predetermined geographic area comprising:
a first interface to interface with the cable head-end or telephone company central office, said first interface including a first plurality of communications modules, each of said first plurality of communications modules capable of communicating according to a particular protocol independently of and simultaneously with the other of said first plurality of communications modules;
a second interface to interface with the plurality of business and residential users, said second interface including at least one coaxial cable interface to couple to a coaxial cable serving one or more of the plurality of business and residential users and one fiber optic cable interface to couple to a fiber optic cable serving one or more of the plurality of business and residential users, said second interface also including a second plurality of communications modules, each of said second plurality of communications modules capable of communicating according to a particular protocol independently of and simultaneously with the other of said second plurality of communications modules; and
a packet switch/router to couple the first plurality of modules of the first interface to the second plurality of modules of the second interface by aggregating traffic from the plurality of business and residential users received via the second plurality of modules to be transmitted over one or more of the first plurality of modules to the cable head-end or telephone company central office and by partitioning traffic from the cable head-end or telephone company central office received via the first plurality of modules to be transmitted over one or more of the second plurality of modules to the plurality of business and residential users.

2. The apparatus according to claim 1, wherein each of said first plurality of communications modules communicates using a different protocol than all of the other communications modules of the first plurality of communications modules.

3. The apparatus according to claim 1, wherein each of said second plurality of communications modules communicates using a different protocol than all of the other communications modules of the second plurality of communications modules.

4. The apparatus according to claim 1, wherein the first plurality of communications modules includes modules capable of communicating using two or more of the following: (1) full-duplex Ethernet over fiber connections; (2) passive-optical-network; and (3) SONET rings.

5. The apparatus according to claim 1, wherein the second plurality of communications modules includes modules capable of communicating using two or more of the following: (1) DOCSIS protocol; (2) full duplex 10/100 Mbps Ethernet over fiber; (3) passive optical networks carrying either ATM or Ethernet frames.

6. The apparatus according to claim 1, wherein the packet switch/router comprises a network processor.

7. A method for communicating narrow-cast data to a plurality of residential and business users comprising:
transmitting narrow-cast data to be transmitted to the plurality of residential and business users as a plurality of packets on a baseband optical link from a cable head-end to said one or more access nodes; and
converting in the one or more access nodes narrow-cast data to be transmitted to one or more users within a group of residential and business users served by said one or more access nodes to RF carriers for transmission to the one or more users along with said broadcast RF carriers.

8. The method according to claim 7, wherein the narrow-cast data includes one ore more of the following: Internet traffic, DOCSIS data, video-on-demand and voice-over-IP.

9. The method according to claim 7, further comprising:
transmitting data between one of the access nodes and one or more users served by said one of the access nodes using a 10/100 Mbps full duplex Ethernet connection; and
converting the data from said one or more users to a second protocol for transmission to the cable head-end over a higher speed optical fiber connection.

10. A method for communicating complete video services including full broadcast video as well as narrow-cast video between a plurality of residential and business users and a cable head-end comprising:
transmitting video from the cable head-end to an access node as a plurality of MPEG packet streams over a base-band optical link;
selecting by each of the users via a control protocol operating between said each of the users and the access node which of the plurality of MPEG packet streams said each user desires to receive; and
switching a selected MPEG packet stream to a lower bandwidth base-band optical link from the access node to said each user.

11. A method for communicating video between a plurality of residential and business users and a cable head-end comprising:
selecting by each of the plurality of residential and business users which of a plurality of MPEG packet streams each user desires to receive using a control protocol operating between each user, the access node served by each user and the cable head-end;
transmitting a plurality of access node selected MPEG packet streams from the cable head-end to an access node serving a group of users of the plurality of residential and business users over a base-band optical link, wherein said plurality of access node selected MPEG packet streams were selected by the group of users; and
switching one or more user selected MPEG packet streams to a lower bandwidth base-band optical link coupling the access node to one or more users of said group of users, wherein said one or more user selected MPEG packet streams were selected by said one or more users.

12. A communications network comprising:
a central node;
one or more mux nodes coupled to the central node via optical fiber links operating at a first data rate, said one or more mux nodes being up to a first distance from said central node;
one or more access nodes coupled to each of the one or more mux nodes via optical fiber links operating at a second data rate at or less than said first data rate, each of said one or more access nodes serving one or more residential or business users, said access node for deployment up to a second distance less than said first distance from the mux node and between said one or more residential or business users within a defined geographic area, said access node further including:
a first interface to interface with the mux node, said first interface including a first plurality of communications modules, each of said first plurality of communications modules capable of communicating according to a particular protocol independently of and simultaneously with the other of said first plurality of communications modules;
a second interface to interface with the one or more business or residential users, said second interface including at least one coaxial cable interface to couple to a coaxial cable serving one or more of the one or more business or residential users and one fiber optic cable interface to couple to a fiber optic cable serving one or more of the one or more business or residential users, said second interface also including a second plurality of communications modules, each of said second plurality of communications modules capable of communicating according to a particular protocol independently of and simultaneously with the other of said second plurality of communications modules; and
a packet switch/router to couple the first plurality of modules of the first interface to the second plurality of modules of the second interface by aggregating traffic from the one or more business or residential users received via the second plurality of modules to be transmitted over one or more of the first plurality of modules to the mux node and by partitioning traffic from the mux node received via the first plurality of modules to be transmitted over one or more of the second plurality of modules to the one or more business or residential users.

13. The network according to claim 12, wherein the first plurality of communications modules includes modules capable of communicating using two or more of the following: (1) full-duplex Ethernet over fiber connections; (2) passive-optical-network; and (3) SONET rings.

14. The network according to claim 12, wherein the second plurality of communications modules includes modules capable of communicating using two or more of the following: (1) DOCSIS protocol; (2) full duplex 10/100 Mbps Ethernet over fiber; (3) passive optical networks carrying either ATM or Ethernet frames.

15. The apparatus according to claim 12, wherein the packet switch/router comprises a network processor.

16. A communications network comprising:
a central node;
one or more access nodes coupled to the central nodes via optical fiber links operating at a first data rate, each of said one or more access nodes serving one or more residential or business users, said access node for deployment up to a second distance less than said first distance from the central node and between said one or more residential or business users within a defined geographic area, said access node further including:
a first interface to interface with the central node, said first interface including a first plurality of communications modules, each of said first plurality of communications modules capable of communicating according to a particular protocol independently of and simultaneously with the other of said first plurality of communications modules;
a second interface to interface with the one or more business or residential users, said second interface including at least one coaxial cable interface to couple to a coaxial cable serving one or more of the one or more business or residential users and one fiber optic cable interface to couple to a fiber optic cable serving one or more of the one or more business or residential users, said second interface also including a second plurality of communications modules, each of said second plurality of communications modules capable of communicating according to a particular protocol independently of and simultaneously with the other of said second plurality of communications modules; and
a packet switch/router to couple the first plurality of modules of the first interface to the second plurality of modules of the second interface by aggregating traffic from the one or more business or residential users received via the second plurality of modules to be transmitted over one or more of the first plurality of modules to the central node and by partitioning traffic from the central node received via the first plurality of modules to be transmitted over one or more of the second plurality of modules to the one or more business or residential users.

17. The network according to claim 16, wherein the first plurality of communications modules includes modules capable of communicating using two or more of the following: (1) full-duplex Ethernet over fiber connections; (2) passive-optical-network; and (3) SONET rings.

18. The network according to claim 16, wherein the second plurality of communications modules includes modules capable of communicating using two or more of the following: (1) DOCSIS protocol; (2) full duplex 10/100 Mbps Ethernet over fiber; (3) passive optical networks carrying either ATM or Ethernet frames.

19. The network according to claim 16, wherein the packet switch/router comprises a network processor.

20. The network according to claim 16, wherein each of said first plurality of communications modules communicates using a different protocol than all of the other communications modules of the first plurality of communications modules.
